(19) United States
(12) Patent Application Publication
(10) Pub. No.: US 2013/0318320 A1
(43) Pub. Date: Nov. 28, 2013

(54) SYNCHRONIZE A PROCESS STATE

(71) Applicant: James M. Mann, Cypress, TX (US)

(72) Inventor: James M. Mann, Cypress, TX (US)

(73) Assignee: Hewlett-Packard Development Company, L.P.

(21) Appl. No.: 13/983,574

(22) PCT Filed: Mar. 14, 2011
(86) PCT No.: PCT/US11/28273

§ 371 Date: Aug. 4, 2013

(51) Int. Cl. G06F 12/02

(52) U.S. Cl. CPC G06F 12/02
USPC 711/165

(57) ABSTRACT

A device to store a process state to a non-volatile storage medium in response to the process state being loaded onto a memory, detect the device entering into a hibernation state, and synchronize stored content from the process state with current content of a current process state before entering the low power state.

### BACKGROUND

If an instruction is detected for a device to enter into a low power state, the device can proceed to detect information and/or data currently loaded onto a memory of the device. Additionally, the device can continue to power the memory to retain the information and/or data. Alternatively, the device can copy the information and/or data from the memory in response to the device entering the low power state and create a hibernation file of the information and/or data. The hibernation file can then be stored onto a hard drive of the device. Once the hibernation file has been stored, the device can proceed to power down the memory and any additional components of the device.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device with a power source, a memory and a non-volatile storage medium according to an embodiment.

FIG. 2 illustrates a power source coupled to components of a device and a process state of the device according to an embodiment.

FIG. 3A illustrates a block diagram of a process state being copied from a memory and to a non-volatile storage medium in response to a device entering a power on state according to an embodiment.

FIG. 3B illustrates a block diagram of a process state of a non-volatile storage medium being synchronized with a current process state if a device is entering a low power state according to an embodiment.

FIG. 4 illustrates a block diagram of a process state of a non-volatile storage medium being synchronized with a current process state in response to detecting a trigger point according to an embodiment.

FIG. 5 illustrates a state application on a device and the state application stored on a removable medium being accessed by the device according to an embodiment.

FIG. 6 is a flow chart illustrating a method for managing a device according to an embodiment.

FIG. 7 is a flow chart illustrating a method for managing a device according to an embodiment.

### DETAILED DESCRIPTION

If a device is entering a power on state, a process state of the device can be loaded onto a memory of the device. In one embodiment, a process state can include content, such as a state of an operating system, one or more sessions, processes, threads, and/or applications which are loaded onto the memory. In response to the process state being loaded onto the memory, a copy of the process state can be stored onto a non-volatile storage medium. By storing a copy of the process state to the non-volatile storage medium, content of the process state can be secured and preserved in response to the device entering the power on state.

Additionally, if the device is detected to be entering a low power state, the stored copy of the process state can be synchronized with a current process state loaded onto the memory. As a result, the stored content on the non-volatile storage medium can be synchronized with current content which is currently loaded onto the memory. In one embodiment, synchronizing the stored content with the current content includes updating the stored content to include any new, updated, and/or different content included in the current process state. By storing a copy of the process state in response to the device entering a power on state and synchronizing the stored process state with a current process state if the device is entering a low power state, an amount of time for the device to enter and/or transition to the low power state can be reduced.

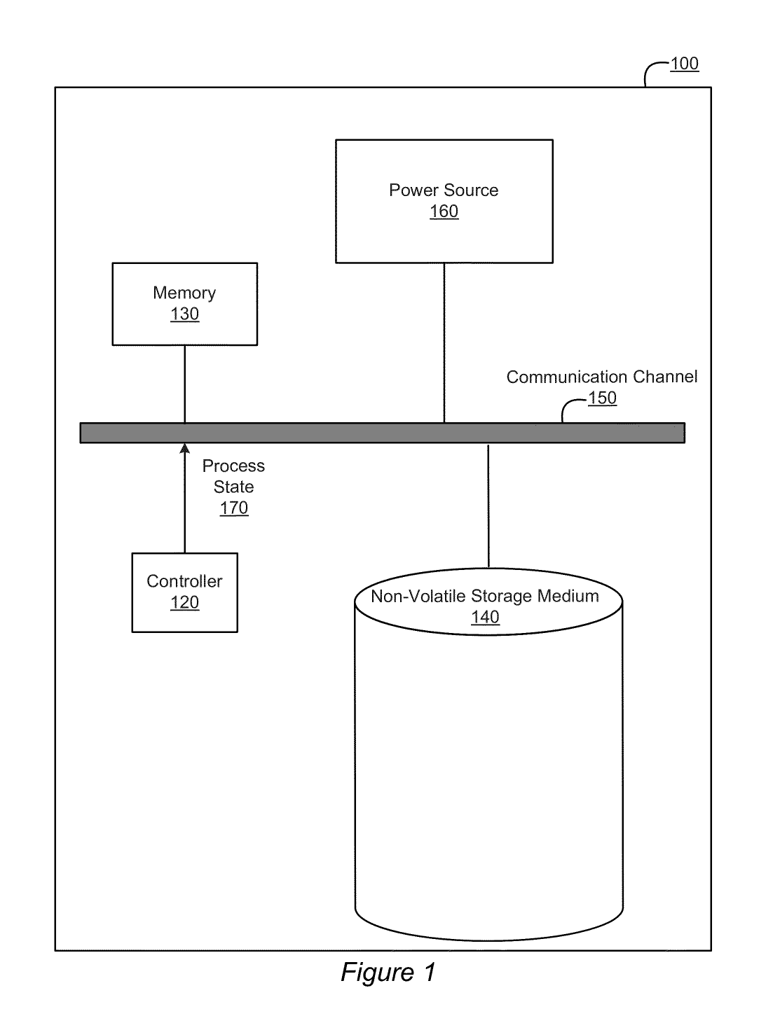

FIG. 1 illustrates a device 100 with a power source 160, a memory 130 and a non-volatile storage medium 140 according to an embodiment. In one embodiment, the device 100 can be a desktop, a laptop, a notebook, a tablet, a netbook, an all-in-one system, a server, and/or the like. In another embodiment, the device 100 can be a cellular device, a PDA, an E-Reader, and/or any additional device which can include a power source 160, memory 130 and a non-volatile storage medium 140.

As illustrated in FIG. 1, the device 100 includes a controller 120, a power source 160, a memory 130, a non-volatile storage memory 140 and a communication channel 150 for the device 100 and/or one or more components of the device 100 to communicate with one another. In one embodiment, the device 100 includes a state application stored on a computer readable medium included in or accessible to the device 100. In other embodiments, the device 100 includes additional components and/or is coupled to additional components in addition to and/or in lieu of those noted above and illustrated in FIG. 1.

As noted above, the device 100 can include a controller 120. The controller 120 can send data and/or instructions to the components of the device 100, such as the power source 160, the memory 130, the non-volatile storage medium 140, and/or the state application. Additionally, the controller 120 can receive data and/or instructions from components of the device 100, such as the power source 160, the memory 130, the non-volatile storage medium 140, and/or the state application.

The state application is an application which can be utilized in conjunction with the controller 120 to manage the device 100. The controller 120 and/or the state application can manage the device 100 as the device 100 enters and/or transitions between one or more power states. For the purposes of this application, one or more power states can include a power on state, a low power state, and/or a power off state. In one embodiment, a low power state can be or include a sleep state (S3) state and/or a hibernation (S4) state.

If the device 100 enters the power on state, the power source 160 can supply power to one or more components of the device 100, such as the controller 120, the memory 130, and/or the non-volatile storage medium 140. The power source 160 is a hardware component of the device 100 configured to manage, control, and/or modify an amount of power supplied to and/or drawn by one or more components of the device 100 to allow the device 100 to enter and/or transition between one or more of the power states.

If entering the power on state, the controller 120 and/or the state application can load a process state 170 of the device 100 onto a memory 130. For the purposes of this application, a process state 170 of the device 100 can include content, such as a state of an operating system, one or more sessions, processes, threads, and/or the applications which are loaded onto the memory 130. Additionally, the content of the process state 170 can include information, data, and/or configuration settings associated with the loaded operating system, sessions, processes, threads, and/or applications.

The memory 130 is a component of the device 100 which can be powered to store the process state 170 of the device 100. In one embodiment, the memory 130 can be or include RAM (Random Access Memory). In response to the process state 170 being loaded onto the memory 130, the controller 120 and/or the state application can store a copy of the process state 170 onto a non-volatile storage medium 140. The non-volatile storage medium 140 is a component of the device 100 configured to receive and store the process state 175 of the device 100. The non-volatile storage medium 140 can store or retain the process state 170 with or without being powered by the power source 160.

Once the process state has been stored and/or copied to the non-volatile storage medium 140, the controller 120 and/or the state application can detect the device 100 entering a low power state. For the purposes of this application, the device 100 can enter and/or transition from the power on state to the low power state in response to the controller 120, the state application, the operating system, the power source 160, another application, and/or a user of the device 100 sending an instruction for the device 100 to enter the low power state.

If the device 100 is entering the low power state, the controller 120 and/or the state application can proceed to synchronize stored content from the process state 170 on the non-volatile storage medium 140 with current content from the current process state. In one embodiment, the controller 120 and/or the state application can additionally synchronize the stored content from the process state 170 with current content from the current process state in response to detecting one or more trigger points. One or more trigger points can be detected if the controller 120 and/or the state application detect: a predefined amount of time elapsing, an event of the device 200, an event of an application, an instruction from a user of the device 100, and/or a change in a power level of the device 200.

For the purposes of this application, synchronizing the stored content with the current content includes the controller 120 and/or the state application detecting the current process state loaded onto the memory 130 to identify any new, updated, and/or different content included in the current process state. In one embodiment, if any new content is detected on the current process state, the controller 120 and/or the state application can update the stored content of the process state 170 to include the new content of the current process state.

In another embodiment, if any updated content is detected on the current process state, the controller 120 and/or the state application can update corresponding content stored on the process state 170 with the updated content of the current process state. Once the stored content of the process state 170 has been synchronized with the current content of the current process state, the controller 120 and/or the state application can transition the device 100 into the low power state. When in the low power state, the power source 160 can stop powering one or more components of the device 100.

The state application can be firmware which is embedded onto the controller 120, the device 100, and/or a storage device coupled to the device 100. In another embodiment, the state application is an application stored on the device 100 within ROM (read only memory) or on the storage device accessible by the device 100. In other embodiments, the state application is stored on a computer readable medium readable and accessible by the device 100 or the storage device from a different location.

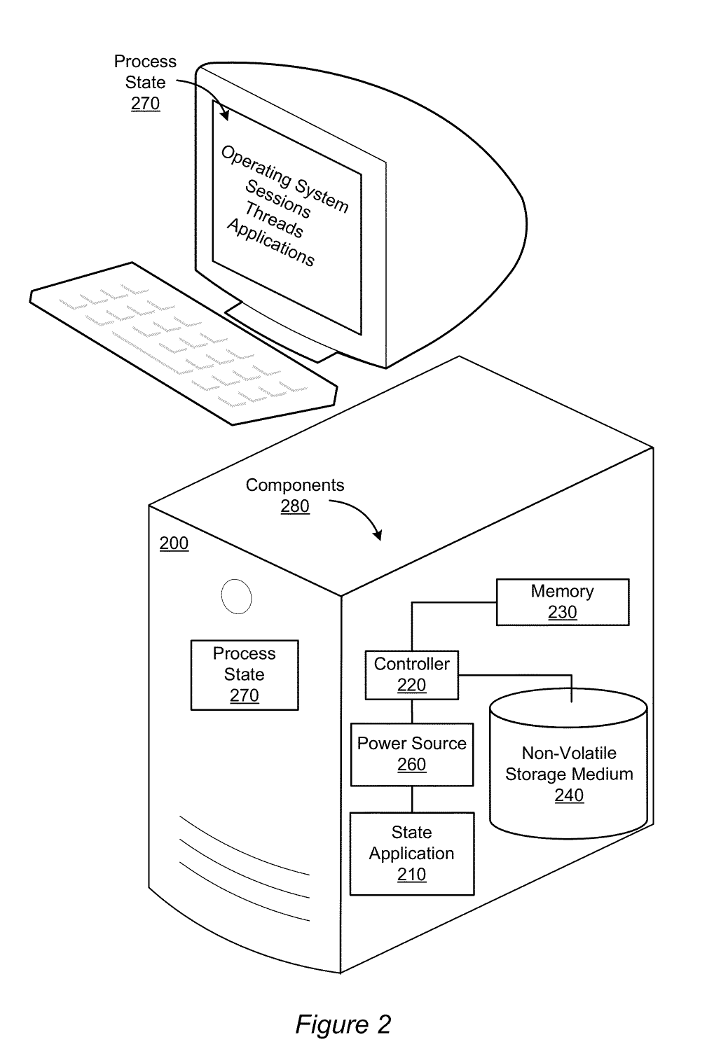

FIG. 2 illustrates a power source 260 coupled to components 280 of a device 200 and a process state 270 of the device 200 according to an embodiment. As noted above, the device 200 can enter into and/or transition between one or more power states in response to a power source 260 of the device 200 modifying an amount of power supplied to one or more components 280 of the device 200. The power source 260 is a component of the device 200 configured to manage, control, and/or modify an amount of power supplied to and/or drawn by one or more of the components 280 to allow the device 200 to enter and/or transition between one or more power states. In one embodiment, the power source 260 can be a power supply of the device 200.

The power source 260 can utilize ACPI (Advanced Configuration and Power Interface) specifications. As noted above, one or more of the power states can include a power on state (S0), a low power state, and/or a power off state (S5). One or more of the low power states can be or include a sleep state (S3) and/or a hibernation state (S4). In other embodiments, the device 200 can utilize difference specifications and the device 200 can enter into and/or transition between one or more additional power states in addition to and/or in lieu of those noted above.

When in the power on state, the power source 260 can supply power to the components 280 of the device 200, such as a controller 220, a memory 230, a display component, and/or a non-volatile storage medium 240 of the device 200. Additionally, when in the power on state, a process state 270 of the device 200 can be loaded onto the memory 230. The memory 230 is a volatile storage component of the computing machine 200 which can receive power from the power source 260 to store a process state 270 of the device 200. In one embodiment, the memory 230 includes RAM (Random Access Memory).

As illustrated in FIG. 2, the process state 270 can include content, such as a state of an operating system, one or more sessions, processes, threads, and/or any applications of the device 200 loaded onto the memory 230 by the controller 220 and/or the state application 210. In one embodiment, the content loaded onto the memory 230 can additionally include data, information, and/or configuration settings associated with the loaded operating system, processes, threads, and/or applications. In other embodiments, the process state 270 can include the state of additional content and/or any additional data in addition to and/or in lieu of those noted above and illustrated in FIG. 2.

In response to the process state 270 being loaded onto the memory 230, the controller 220 and/or the state application 210 can proceed to store a copy of the process state onto a non-volatile storage medium 240 of the device 200. The non-volatile storage medium 240 is a storage device configured to receive and store information and/or data, such as a copy of the process state 270. The non-volatile storage medium 240 can store the information and/or data with or without receiving power from the power source 260. In one embodiment, the non-volatile storage medium 240 can be or include a solid state storage device, a flash memory storage device, and/or any hard drive of the device 200.

As noted above, the device 200 can additionally transition from the power on state to a low power state. The low power state can include a hibernation (S4) state. The device 200 can enter and/or transition into the low power state in response to the controller 220, the state application 210, the operating system, the power source 260, and/or another application sending an instruction for the device 200 to enter the low power state. In another embodiment, the device 200 can enter and/or transition into the low power state in response to a predetermined amount of time elapsing, in response to a power level of the power source 260 falling below a predefined amount of power, and/or in response to the controller 220 and/or the state application 210 detecting an event from the device 200.

If the device 200 is detected to be entering the low power state, the controller 220 and/or the state application 210 can proceed to synchronize the stored process state 270 on the non-volatile storage medium 240 with a current process state loaded onto the memory 230. For the purposes of this application, the current process state corresponds to current content which is currently loaded onto the memory 230. The current process state can include new content or updated content which is different from the content included in the stored process state 270.

In one embodiment, the current content can include a current state of the operating system, one or more sessions, processes, threads, and/or any applications which are currently loaded onto the memory 230. In another embodiment, the current process state includes any current data, information, and/or configuration settings associated with the loaded operating system, processes, threads, and/or applications from the memory 230. Once the stored process state 270 has been synchronized with the current process state, the controller 220 and/or the state application 210 can configure the device 200 to enter into the low power state.

If the device 200 is entering and/or transitioning to a low power state, the power source 260 can reduce or cease supplying an amount of power to one or more components of the device 200, such as the controller 220, the memory 230, the non-volatile storage medium 240, and/or any additional component of the device 200. While in the low power state, the process state 270 of the device 200 can be retained in the non-volatile storage medium 240 as one or more components 280 of the device 200 are powered down for the device 200.

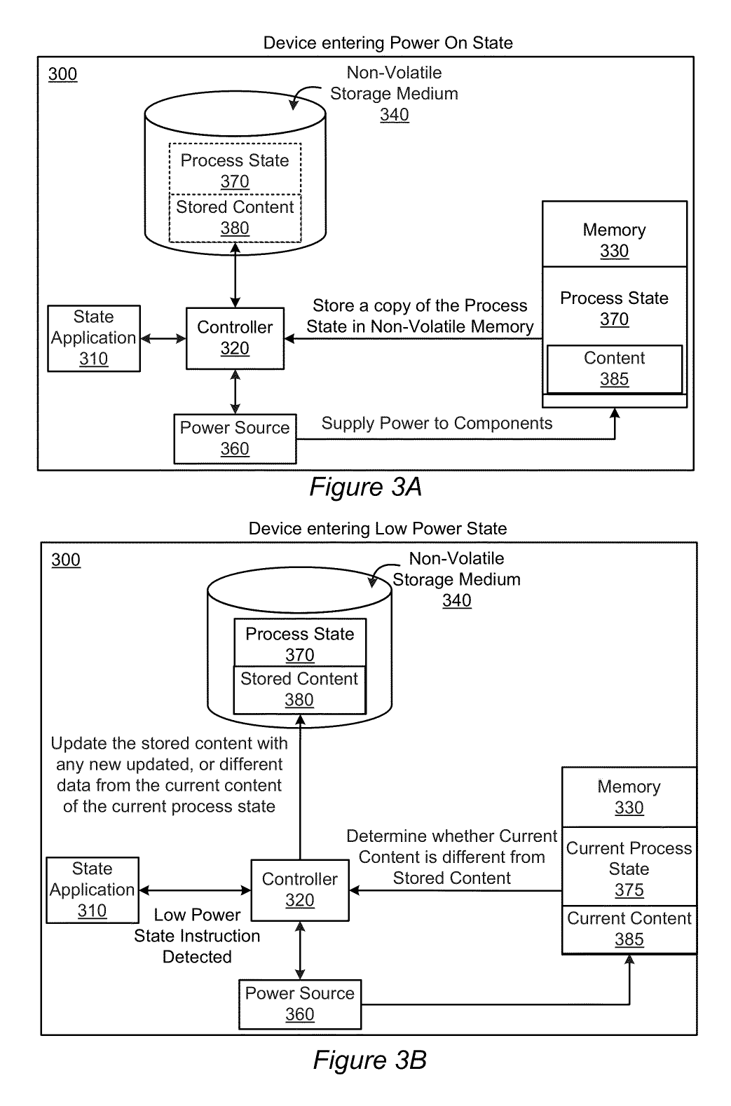

FIG. 3A illustrates a block diagram of a process state 370 being copied from a memory 330 and to a non-volatile storage medium 340 in response to a device 300 entering a power on state according to an embodiment. As noted above, when the device 300 is in a power on state, a power source 360 can supply power to one or more components of the device 300, such as the memory 330. Additionally, when powered, a process state 370 of the device 300 can be loaded and retained on the memory 330. In response to the process state 370 being loaded onto the memory 330, the controller 320 and/or the state application 310 can proceed to store a copy of the process state 370 onto a non-volatile storage medium 340.

When storing the process state 370, the controller 320 and/or the state application 310 can access the memory 330 and copy the process state 370 to be stored onto the non-volatile storage medium 340. In one embodiment, when copying the process state 370, the controller 320 and/or the state application 310 can initially access content 380 loaded onto the memory 330 and identify a state of an operating system, one or more sessions, processes, threads, and/or any applications as a copy of the process state 370 to be stored on the non-volatile storage medium 340. In another embodiment, the controller 320 and/or the state application 310 can additionally identify any data, information, and/or configuration settings associated with the loaded operating system, processes, threads, and/or applications loaded onto the memory 330.

The controller 320 and/or the state application 310 can then copy any of the identified content 380 from the memory 330 and proceed to store the copied content 380 as a process state 370 stored on the non-volatile storage medium 340. The content 380 of the process state 370 can be stored on the non-volatile storage medium 340 as an image file, a bitmap file, and/or as any additional data file. In one embodiment, the content 380 of the process state 370 can be additionally compressed to reduce an amount of time for the controller 320 and/or the state application 310 to write the process state 370 to the non-volatile storage medium 340. In another embodiment, the content 380 of the process state 370 can be encrypted using one or more encryption algorithms or security methods to increase security for the device 300.

FIG. 3B illustrates a block diagram of a process state 370 of a non-volatile storage medium 340 being synchronized with a current process state 375 if a device 300 is entering a low power state according to an embodiment. As noted above, the device 300 can enter and/or transition into the low power state in response to the controller 320, the state application 310, an operating system of the device 300, the power source 360, another application, and/or a user of the device 300 sending an instruction for the device 300 to enter the low power state. In one embodiment, when entering the low power state, the device 300 can enter a hibernation (S4) state.

When entering the low power state, the controller 320 and/or the state application 310 can synchronize the copy of the stored process state 370 on the non-volatile storage medium 340 with a current process state 375 which is currently loaded onto the memory 330. As noted above, the current process state 375 corresponds to current content 385 which is currently loaded onto the memory 330. Additionally, the current process state 385 can include new content 385 or updated content 385 which is different from the stored content 380 included in the stored process state 370.

When synchronizing the stored process state 370 with the current process state 375, the controller 320 and/or the state application 310 can synchronize the stored content 380 from the stored process state 370 with current content 385 from the current process state 375. In one embodiment, the controller 320 and/or the state application 310 can access the current content 385 on the memory 330 to identify a current state of the operating system, one or more sessions, processes, threads, and/or any applications which are currently loaded onto the memory 330. In another embodiment, the controller 320 and/or the state application 310 can additionally identify any current data, information, and/or configuration settings associated with the loaded operating system, processes, threads, and/or applications from the memory 330.

The controller 320 and/or the state application 310 can then compare the stored content 380 with the current content 385 to determine whether the current content 385 is different from the stored content 380. In one embodiment, the stored content 380 is different from the current content 385 if the current content 385 includes new data not included in stored content 380. In another embodiment, the current content 385 is different from the stored content 380 if current content 385 includes corresponding data from the stored content 380 which has been modified and/or updated. In other embodiments, the current content 385 is different from the stored content 380 if the stored content 380 includes data which has been removed from the current content 385.

The controller 320 and/or the state application 310 can then proceed to update the stored content 380 on the non-volatile storage medium 340 to add any new content, modify an existing content which has been modified or updated, and remove any content which is no longer included in the current content 385. If any of the current content 385 is determined by the controller 320 and/or the state application 310 to not be different from the stored content 380, the controller 320 and/or the state application can leave the corresponding content as is and not overwrite the corresponding content. Once the stored process state 370 has been synchronized with the current process state 375, the device 300 can enter and/or transition into the low power state.

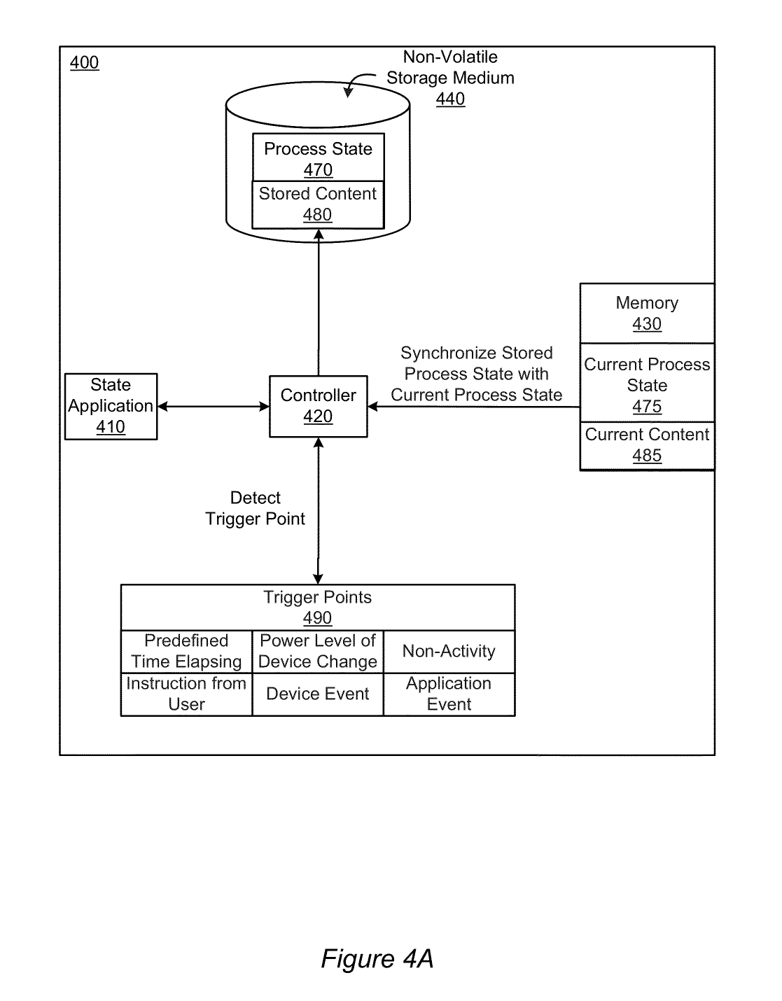

FIG. 4 illustrates a block diagram of a process state 470 of a non-volatile storage medium 440 being synchronized with a current process state 475 in response to detecting a trigger 490 point according to an embodiment. The controller 420 and/or the state application 410 can detect for one or more of the trigger points 490 if the device 400 is in a power on state. The controller 420 and/or the state application 410 can actively, periodically, and/or upon request detect for one or more trigger points 490. In one embodiment, the controller 420 and/or the state application 410 can detect for one or more trigger points 490 before detecting an instruction for the device 400 to enter a low power state. In another embodiment, the instruction for the device 400 to enter the low power state can be identified by the controller 420 and/or the state application 410 to be a trigger point 490.

As shown in the present embodiment, one or more trigger points 490 can be or include a predefined amount of time elapsing, an event of the device 400 occurring, an event of an application occurring 400, a user issuing a trigger instruction to the device 400, and/or a power level of the device 400 changing. One or more of the trigger points 490 can be defined by the controller 420, the state application 410 and/or by a user of the device 400. In other embodiments, the device 400 can include additional trigger points 490 in addition to and/or in lieu of those noted above and illustrated in FIG. 4.

If one or more trigger points 490 have been detected, the controller 420 and/or the state application 410 can proceed to synchronize the process state 470 stored on the non-volatile storage medium 440 with a current process state 475 loaded onto the memory 430. As noted above, when synchronizing the process states, the controller 420 and/or the state application 410 can synchronize the stored content 480 included as the stored process state 470 with the current content 485 included as the current process state 475.

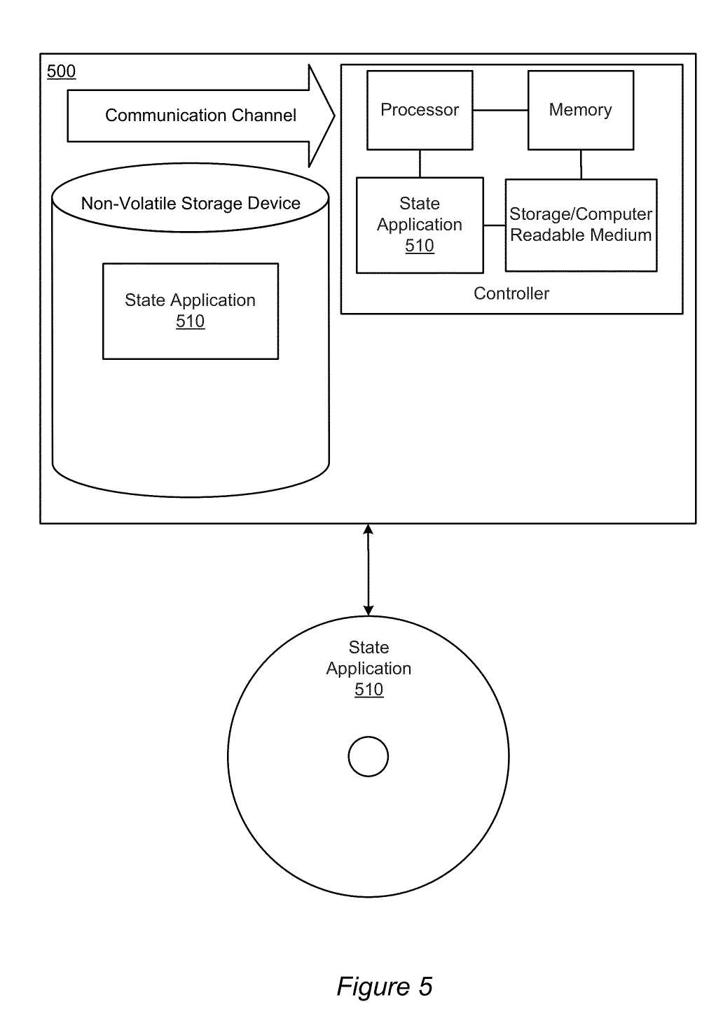

FIG. 5 illustrates a state application 510 on a device 500 and the state application 510 stored on a removable medium being accessed by the device 500 according to an embodiment. For the purposes of this description, a removable medium is any tangible apparatus that contains, stores, communicates, or transports the application for use by or in connection with the device 500. As noted above, in one embodiment, the state application 510 is firmware that is embedded into one or more components of the device 500 as ROM. In other embodiments, the state application 510 is an application which is stored and accessed from a hard drive, a compact disc, a flash disk, a network drive or any other form of computer readable medium that is coupled to the device 500.

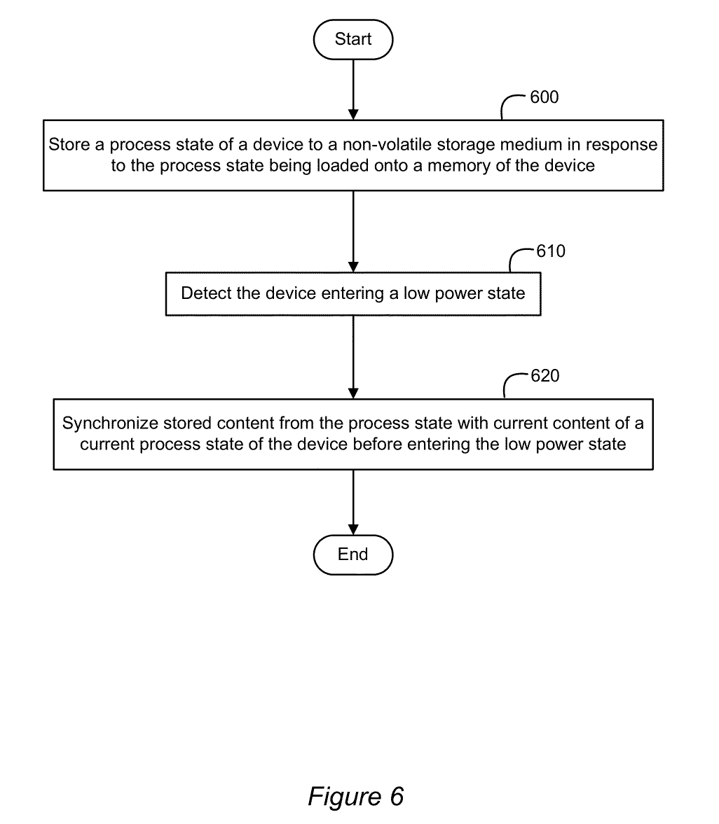

FIG. 6 is a flow chart illustrating a method for managing a device according to an embodiment. The method of FIG. 6 uses a device with a controller, a power source, a memory, a non-volatile storage medium, and/or a state application. In other embodiments, the method of FIG. 6 uses additional components and/or devices in addition to and/or in lieu of those noted above and illustrated in FIGS. 1, 2, 3, 4, and 5.

As noted above, the state application is a software application which can be utilized independently and/or in conjunction with the controller to manage the device. When managing the device, the controller and/or the state application can store a process state of the device to a non-volatile storage medium in response to the process state being loaded onto a memory of the device at 600. The process state of the device can include content, such as a state of an operating system, one or more sessions, processes, threads, and/or the applications which are loaded onto the memory. Additionally, the content of the process state can include information, data, and/or configuration settings associated with the loaded operating system, sessions, processes, threads, and/or applications.

The process state can be loaded onto the memory in response to the device entering a power on (S0) state. The memory can include volatile memory, such as RAM, which can be powered to retain data or information. When in the power on state, the power source can supply power to one or more components of the device. The power source is a hardware component of the device configured to modify an amount of power supplied to one or more components of the device for the device to enter and/or transition between one or more power states.

The controller and/or the state application can access the memory to copy the content included in the process state and store a copy of the process state and the content to a non-volatile storage medium. As noted above, the non-volatile storage medium is a storage component of the device configured to receive and store the process state of the device. Once the process state and the content have been received, the non-volatile storage medium can store or retain the process state with or without being powered by the power source.

The controller and/or the state application can then detect the device entering a low power state at 610. The low power state can be a hibernation (S4) state. The device can enter and/or transition from the power on state to the low power state in response to the controller, the state application, the operating system, the power source, another application, and/or a user of the device sending an instruction for the device to enter the low power state.

If an instruction for the device to enter the low power state is detected, the controller and/or the state application can proceed to synchronize the stored content from the process state with current content of a current process state before the device enters the low power state at 620. As noted above, when synchronizing the stored content of the process state with the current content of the current process state, the controller and/or state application can determine whether the two process states are different.

The controller and/or the state application can synchronize the two process states by adding any new data from the current content, updating or modifying any corresponding data of the stored content with updated or modified data of the current content, and/or by removing any data of the stored content no longer included in the current content. The method is then complete. In other embodiments, the method of FIG. 6 includes additional steps in addition to and/or in lieu of those depicted in FIG. 6.

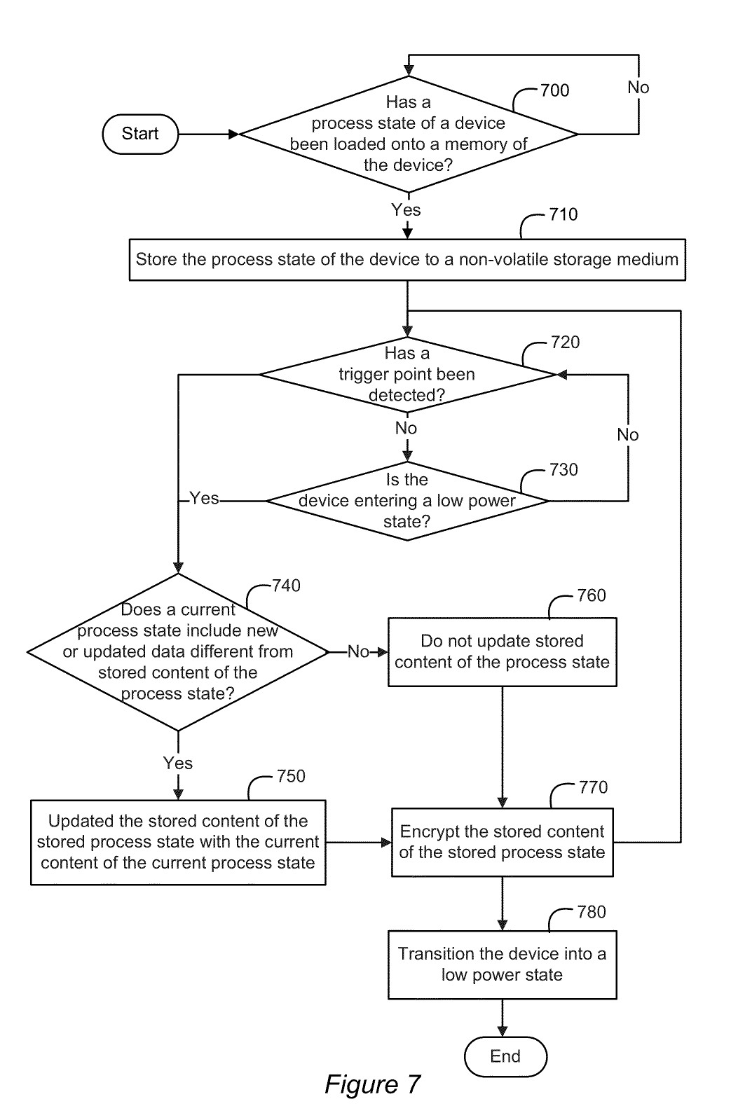

FIG. 7 is a flow chart illustrating a method for managing a device according to another embodiment. Similar to the method disclosed above, the method of FIG. 7 uses a device with a controller, a power source, a memory, a non-volatile storage medium, and/or a state application. In other embodiments, the method of FIG. 7 uses additional components and/or devices in addition to and/or in lieu of those noted above and illustrated in FIGS. 1, 2, 3, 4, and 5.

The controller and/or the state application can initially determine whether a process state of the device has been loaded onto a memory of the device 700. The controller and/or the state application can access the memory and determine whether any content has been loaded onto the memory. The content can include a state of an operating system, one or more sessions, processes, threads, and/or the applications which are loaded onto the memory. Additionally, the content of the process state can include information, data, and/or configuration settings associated with the loaded operating system, sessions, processes, threads, and/or applications.

If no content is detected on the memory, the controller and/or the state application can determine that the process state is not loaded onto the memory and continue to detect a process state of the device 700. If any content has been loaded onto the memory, the controller and/or the state application will proceed to state the process state of the device to a non-volatile storage memory 710. As noted above, when storing the process state, the controller and/or the state application can copy the content loaded onto the memory and store the content as the process state onto the non-volatile storage memory as one or more file types. In one embodiment, the content can additionally be compressed and/or encrypted.

The controller and/or the state application can then determine whether a trigger has been detected 720. As noted above, a trigger point can be or include a predefined amount of time elapsing, an event of the device occurring, an event of an application occurring, a user issuing a trigger instruction to the device, and/or a power level of the device changing. If a trigger point has been detected, the controller and/or the state application can proceed to synchronize the stored process state with a current process state loaded onto the memory.

If no trigger point has been detected, the controller and/or the state application can continue to detect for a trigger point. In another embodiment, the controller and/or the state application can additionally determine whether the device is entering a low power state 730. If no instruction is detected for the device to enter the low power state, the controller and/or the state application can continue to detect for a trigger point and/or the device entering the low power state 720, 730. If an instruction is detected for the device to enter the low power state, the controller and/or the state application can proceed to synchronize the stored process state with the current process state.

As noted above, when synchronizing the two process states, the controller and/or the state application can determine whether the current content included in the current process state includes new data, updated or modified data corresponding to data of the stored process state, and/or excludes data corresponding to data of the stored process state 740. If no differences between the two process states are detected, the controller and/or the state application will not update the stored content of the stored process state 760. The controller and/or the state application can then encrypt the stored content of the process state with one or more encryption algorithms or other additional security methods 770.

In another embodiment, if the controller and/or the state application detect any new, modified and/or excluded data, the controller and/or the state application can proceed to update the stored content of the stored process state to include the differences from the current content of the current process state 750. The controller and/or the state application can then proceed to encrypt the updated stored content of the stored process state 770. Once the stored content of the stored process state has been synchronized, the device can transition into a low power state 780. In one embodiment, when transitioning to the low power state, the device can transition into a hibernation state (S4).

The device can enter into the low power state in response to the power source reducing and/or ceasing supplying power to one or more components of the device. The method is then complete. In other embodiments, the method of FIG. 7 includes additional steps in addition to and/or in lieu of those depicted in FIG. 7.

What is claimed is:

1. A method for managing a device comprising:
storing a process state of a device to a non-volatile storage medium in response to the process state being loaded onto a memory of the device;
detecting the device entering into a low power state; and
synchronizing stored content from the process state with current content of a current process state of the device before entering the low power state.

2. The method for managing the device of claim 1 wherein synchronizing the stored content with the current content includes determining whether the current content is different from the stored content.

3. The method for managing the device of claim 2 wherein the stored content is updated with the current content if the current content includes data not included in the stored content.

4. The method for managing the device of claim 2 wherein the stored content is updated with the current content if corresponding data of the stored content has been updated in the current content.

5. The method for managing the device of claim 2 wherein the stored content is not overwritten with the current content if the stored content is not different from the current content.

6. The method for managing the device of claim 1 further comprising determining whether a trigger point has been detected before detecting the device entering the low power state.

7. The method for managing the device of claim 6 further comprising synchronizing the stored content with the current content in response to detecting the trigger point.

8. A device comprising:
a power source to manage power supplied to components of the device;
a memory to retain a process state of the device if the device is in a power on state;
a non-volatile storage medium to store the process state if the process state is retained on the memory; and
a controller to detect a current process state of the device if the device is entering a low power state and synchronize stored content of the process state with current content of the current process state before the device enters the low power state.

9. The device of claim 8 wherein the device is in an S0 power state when in the power on state and the device is in a S4 power state when in the low power state.

10. The device of claim 8 wherein the memory does not retain content of the process state of the device if the device is in the S4 power state.

11. The device of claim 8 wherein the controller can detect a current process state from the memory and update the stored process state with the current process state if a trigger point of the device is detected.

12. The device of claim 11 wherein the trigger point includes at least one of a predefined amount of time elapsing, an event of the device being detected, an event of an application of the device detected, an instruction from a user of the device, and a change in a power level of the device being detected.

13. A computer readable medium comprising instructions that if executed cause a controller to:
store a process state of a device to a non-volatile storage medium if the process state is loaded onto the memory;
determine whether current content of a current process state of the device is different from stored content of the stored process state if the device is entering a low power state; and
synchronize the current process state with the stored process before the device enters the low power state.

14. The computer readable medium comprising instructions of claim 13 wherein the controller encrypts the stored content of the process state on the non-volatile storage medium.

15. The computer readable medium comprising instructions of claim 13 wherein content included in a process state of the device includes at least one of an operating system, a session of the operating system, a thread, an application, a configuration setting, and data loaded onto the memory of the device.
